(19) United States
(12) Patent Application Publication
(10) Pub. No.: US 2022/0386180 A1
(43) Pub. Date: Dec. 1, 2022

(54) CONTROL APPARATUS, WIRELESS COMMUNICATION SYSTEM, COMMUNICATION CONTROL METHOD AND PROGRAM

(71) Applicant: NIPPON TELEGRAPH AND TELEPHONE CORPORATION, Tokyo (JP)

(72) Inventors: Yohei KATAYAMA, Musashino-shi, Tokyo (JP); Yosuke FUJINO, Musashino-shi, Tokyo (JP); Kazumitsu SAKAMOTO, Musashino-shi, Tokyo (JP)

(73) Assignee: NIPPON TELEGRAPH AND TELEPHONE CORPORATION, Tokyo (JP)

(21) Appl. No.: 17/765,201

(22) PCT Filed: Oct. 4, 2019
(86) PCT No.: PCT/JP2019/039258

§ 371 Date: Mar. 30, 2022

(51) Int. Cl. H04W 28/24; H04W 48/16; H04W 72/12; H04W 72/04

(52) U.S. Cl. CPC H04W 28/24; H04W 48/16; H04W 72/1247; H04W 72/0446

(57) ABSTRACT

A control device includes a logic slot allocation unit and a logic slot notification unit. The logic slot allocation unit generates a set of one or more terminals such that each terminal included in the same set has at least one receiving base station, which is a base station that receives wireless communication from the terminal, and allocates each generated set to a logic slot that has a different combination of a channel and a transmission sequence number. The logic slot notification unit notifies each terminal of the logic slot that was allocated to the terminal.

### TECHNICAL FIELD

The present invention relates to a control device, a wireless communication system, a communication control method, and a program.

### BACKGROUND ART

LPWA (Low Power, Wide Area) is a wireless communication technology that can enable communication over a wide area with low power consumption. LoRa (registered trademark) is one example of a LPWA communication method (see NPL 1). In LoRa (registered trademark), terminals compatible with LPWA (hereinafter referred to as “LPWA terminals”) perform communication with a control device via a plurality of base stations, for example.

LPWA terminals sometimes have a function for holding terminal data that indicates whether an abnormality has occurred in a device such as a sensor or a meter. For example, in the event of a large-scale disaster such as an earthquake, there may be a desire for the control device to quickly collect the terminal data held by all LPWA terminals and check the collected terminal data.

### CITATION LIST

### Non Patent Literature

[NPL 1] “LoRaWAN® 1.1 Specification”, [online], the LoRa Alliance Technical Committee, Oct. 11, 2017, [retrieved Mar. 11, 2019], Internet <URL: https://lora-alliance.org/sites/default/files/2018-04/lorawantm_specification_-v1.1.pdf>

### SUMMARY OF THE INVENTION

### Technical Problem

If LPWA terminals attempt to communicate with the control device at the same time in accordance with an autonomous judgment made in abnormality detection or in accordance with a multicast instruction, most of the communication attempts will fail due to interference between. communication attempts performed by LPWA terminals that are geographically close to each other. In such a case, if the terminals that had a communication failure repeatedly perform retransmission without limitation at randomly shifted timings, terminal data can eventually be collected from all LPWA terminals whose terminal data is to be collected. However, this takes a very long time.

In view of the above circumstances, an object of the present invention is to provide a control device, a wireless communication system, a communication control method, and a program that are capable of shortening the time required to collect information from a large number of wireless communication terminals at the same time.

### Means for Solving the Problem

One aspect of the present invention is a control device including: a logic slot allocation unit configured to generate a set of one or more terminals such that each terminal included in the same set has at least one receiving base station, which is a base station that receives wireless communication from the terminal, and configured to allocate each generated set to a logic slot that has a different combination of a channel and a transmission sequence number; and a logic slot notification unit configured to notify each terminal of the logic slot that was allocated to the terminal.

Another aspect of the present invention is a wireless communication system including a plurality of terminals and the control device described above, the control device further including a transmission request unit configured to transmit a transmission request for data to the terminals by multicast, and each of the terminals including: a logic slot notification acquisition unit configured to acquire a logic slot notification from the control device; a transmission request acquisition unit configured to receive the transmission request from the control device; and a data transmission unit configured to, in a case where the transmission request acquisition unit received the transmission request, pause transmission until arrival of a transmission timing calculated using the transmission sequence number indicated by the logic slot, and configured to transmit data using a channel number indicated by the logic slot at the transmission timing.

Another aspect of the present invention is a communication control method including: a logic slot allocation step of generating a set of one or more terminals such that each terminal included in the same set has at least one receiving base station, which is a base station that receives wireless communication from the terminal, and allocating each generated set to a Ionic slot that has a different combination of a channel and a transmission sequence number; and a logic slot notification step of notifying each terminal of the logic slot that was allocated to the terminal.

Another aspect of the present invention is a program for causing a computer to function as the control device described above.

### Effects of the Invention

According to the present invention, it is possible to shorten the time required to collect information from a large number of wireless communication terminals at the same time.

### BRIEF DESCRIPTION OF DRAWINGS

FIG. 1 is a diagram showing an example of the overall configuration of a wireless communication system 1 according to a first embodiment of the present invention.

FIG. 2 is a diagram for describing an example of a problem in the case where transmission timing is not controlled.

FIG. 3 is a block diagram showing a functional configuration of a control device 10 according to the first embodiment of the present invention.

FIG. 4 is a diagram showing a configuration of a reception power value holding table D1 used in the control device 10 according to the first embodiment of the present invention.

FIG. 5 is a diagram showing a configuration of a transmission sequence calculation table D2 used in the control device 10 according to the first embodiment of the present invention

FIG. 6 is a diagram showing a configuration of a logic slot holding table D3 used in the control device 10 according to the first embodiment of the present invention,

FIG. 7 is a block diagram showing a functional configuration of a terminal 20 according to the first embodiment of the present invention.

FIG. 8 is a sequence diagram showing operations of the wireless communication system 1 according to the first embodiment of the present invention.

FIG. 9 is a flowchart showing operations of logic slot calculation performed by the control device 10 according to the first embodiment of the present invention.

FIG. 10 is a flowchart showing operations of logic slot calculation performed by the control device 10 according to the first embodiment of the present invention.

FIG. 11 is a block diagram showing a functional configuration of a control device 10a according to a second embodiment of the present invention.

FIG. 12 is a block diagram showing a functional configuration of a terminal 20a according to the second embodiment of the present invention.

FIG. 13 is a sequence diagram showing operations of a wireless communication system la according to the second embodiment of the present invention

FIG. 14 is a diagram showing a hardware configuration of the control device 10 according to the first embodiment of the present invention.

### DESCRIPTION OF EMBODIMENT

### First Embodiment

Hereinafter, a first embodiment of the present invention will be described with reference to the drawings.

[Configuration of Wireless Communication System]

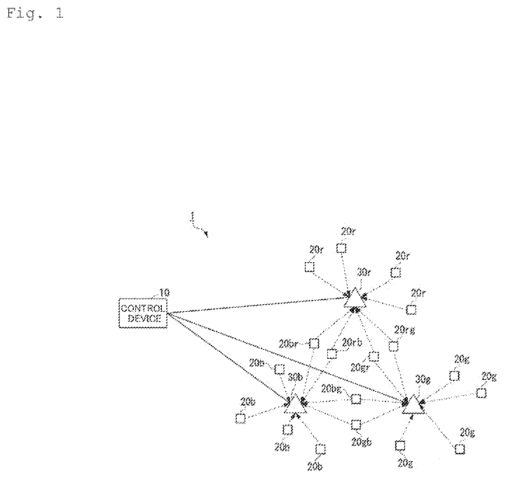

Hereinafter, the configuration of a wireless communication system 1 will be described. FIG. 1 is a diagram showing an example of the overall configuration of the wireless communication system 1 according to the first embodiment of the present invention. As shown in FIG. 1, the wireless communication system 1 includes a control device 10, a plurality of terminals 20, and a plurality of base stations 30. In FIG. 1, terminals 20r, 20g, 20b, 2g, 20rb, 20gb, 20gr, 20br, and 20bg are shown as the plurality of terminals 20. Also, in FIG. 1, base stations 30r, 30g, and 30b are shown as the plurality of base stations 30. The term “terminal 20” will be used when it is not necessary to distinguish between the terminals 20r, 20g, 20b, 20rg, 20rb, 20gb, 20gr, 20br, and 20bg, and the term “base station 30” will be used when it is not necessary to distinguish between the base stations 30r, 30g, and 30b. Communication in the direction from a terminal 20 to the control device 10 is uplink communication. Communication in the direction from the control device 10 to a terminal 20 is downlink communication The plurality of terminals 20 are categorized as follows.

The terminal 20r is a terminal 20 whose packet transmission, that is to say uplink communication from the terminal, can be received by only the base station 30r. The terminal 20r is located. only in the range of the cell configured by the base station 30r.

The terminal 20g is a terminal 20 whose uplink communication can be received by only the base station 30g. The terminal 20g is located only in the range of the cell configured by the base station 30g.

The terminal 20b is a terminal 20 whose uplink communication can be received by only the base station 30b. The terminal 20b is located only in the range of the cell configured by the base station 30b.

The terminal 20rg is a terminal 20 whose uplink communication can be received by the base station 30r and the base station 30g. The terminal 20rg is located in a range of overlap between the range of the cell configured by the base station 30r and the range of the cell configured by the base station 30g.

The terminal 20rb is a terminal 20 whose uplink communication can be received by the base station 30r and the base station 30b. The terminal 20rb is located in a range of overlap between the range of the cell configured by the base station 30r and the range of the cell configured by the base station 30b.

The terminal 20gb is a terminal 20 whose uplink communication can be received by the base station 30g and the base station 30b. The terminal 20gb located in a range of overlap between the range of the cell configured by the base station 30g and the range of the cell configured by the base station 30b.

The terminal 20gr is a terminal 20 whose uplink communication can be received by the base station 30q and the base station 30r. The terminal 20gr is located in a range of overlap between the range of the cell configured by the base station 30g and the range of the cell configured by the base station 30r.

The terminal 20br is a terminal 20 whose uplink communication can be received by the base station 30b and the base station 30r. The terminal 20br is located in a range of overlap between the range of the cell configured by the base station 30b and the range of the cell configured by the base station 30r.

The terminal 20bg is s terminal 20 whose uplink communication can be received by the base station 30b and the base station 30a. The terminal 20bg is located in a range of overlap between the range of the cell configured by the base station 30b and the range of the cell configured by the base station 30g.

If uplink communication is performed using overlapping frequencies for example by terminals 20 that are located in the range of the cell configured by one base station 30, interference occurs in such uplink communication at that base station 30.

The control device 10 is an information processing device such as a general-purpose computer, for example. The control device 10 has a transmission/reception function for communicating with the terminals 20 via the base stations 30 and transmitting and receiving data to and from the terminals 20. The control device 10 also has a communication control function for controlling the transmission timing of data transmitted by the terminals 20 to the control device 10 via the base stations 30. Note that the data transmission; reception function and the communication control function may be provided in separate information processing devices. Also, the communication control function can also be applied in the case where each terminal 20 controls the transmission timing of data transmitted to a destination via a base station 30.

Each base station 30 relays communication between the control device 10 and terminals 20. The base station 30 and the terminals 20 are connected by wireless communication. This wireless communication is performed by an LPWA communication method such as LoRa (registered trademark), for example. Note that the control device 10 and the base stations 30 may be connected by wireless communication or by wired communication.

Each terminal 20 is an information processing device such as a general-purpose computer, for example. The terminal 20 communicates with the control device 10 via a base station 30 and transmits and receives data to and from the control device 10. The terminal 20 has a data transmission function for pausing transmission until arrival of a transmission timing under control of the control device 10, and transmitting packets to the control device 10 via a base station 30 at the transmission timing.

[Example of Issue in Case Where Transmission Timing is Not Controlled]

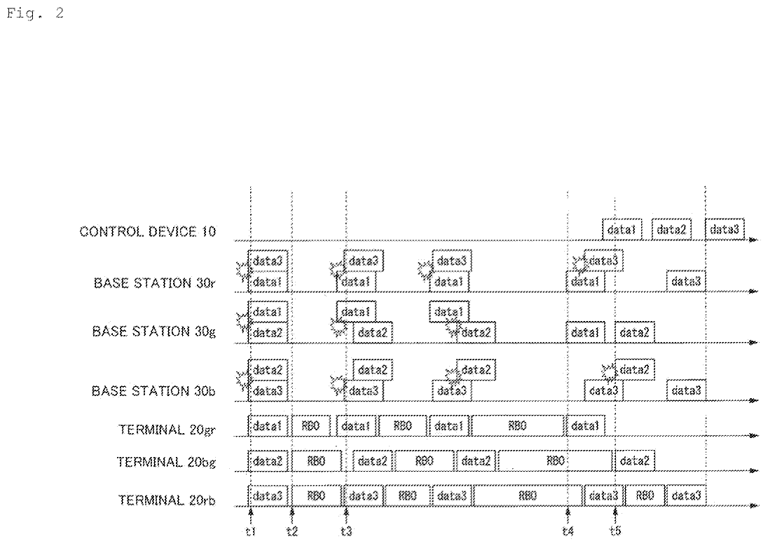

Hereinafter, an example in which radio wave interference and packet retransmission occur 1n the case where terminals 20 do not control the transmission timing of data transmitted to the control device 10 via the base stations 30 will be described with reference to FIG. 2.

FIG. 2 is a diagram for describing an example of a problem in the case where transmission timing is not controlled. In FIG. 2, “RBO” indicates a period during which communication between a base station 30 and terminals 20 is stopped due to the randomization of transmission timings. There is one terminal 20gr, one terminal 20bg, and one terminal 20rb.

The terminal 20gr transmits terminal data data1, the terminal 20bg transmits terminal data data2, and the terminal 20rb transmits terminal data data3 by uplink communication. As shown in FIG. 2, at time t1, the timings of the uplink communication performed by the terminal 20gr, the terminal 20bg, and the terminal 20rb overlap each other. Accordingly, in the base station 30r, the base station 30g, and the base station 30b, the radio waves of two or more uplink communication attempts (i.e., the uplink communication attempts of the terminal 20gr, the terminal 20bg, and the terminal 20rb) interfere with each other. If the two or more uplink communication attempts all reach the base station 30r, the base station 30g, and the base station 30b with the same strength, the base station 30r, the base station 30g, and the base station 30b all cannot receive any of the uplink communication attempts. In other words, at time t1, a reception error occurs in the base station 30r, the base station 30g, and the base station 30b.

At time t2, each terminal 20 among the terminal 20gr, the terminal 20bg, and the terminal 20rb that had a communication failure performs retransmission at a randomly shifted timing by suspending communication during the “RBO” period. However, at time t3, if interference occurs in the uplink communication of the terminal data data1 retransmitted by the terminal 20gr, the terminal data data2 retransmitted by the terminal 20bg, and the terminal data data3 retransmitted by the terminal 20rb, then the base station 30r, the base station 30g, and the base station 30b all cannot receive any of the uplink communication attempts. In this case, the terminal 20gr, the terminal 20bg, and the terminal 20rb each repeat the operation of performing retransmission at a randomly shifted timing until the uplink communication is successful.

If the terminal 20gr and the terminal 20bg that had a communication failure can perform uplink communication of the terminal data data2 and uplink communication of the terminal data data2 at timings that do not interfere with. another terminal 20, such as at time t4 and time t5, the base station 30g receives those uplink communication attempts. The base station 30g transmits the received uplink communication to the control device 10.

On the other hand, as shown at time t4 and time t5, at both the base station 30r and the base station 30b, a reception error occurs in the uplink communication performed by the terminal 20rb that had a communication failure, due to interference with the uplink communication of other terminals 20. The terminal 20rb repeats the operation of performing retransmission at a randomly shifted timing until the uplink communication is successful.

Although the above is an example in which three terminals 20 perform uplink communication at interfering timings, as the number of terminals 20 that perform uplink communication at interfering timings increases, the number of retransmissions required for successful communication becomes very large.

[Functional Configuration of Control Device]

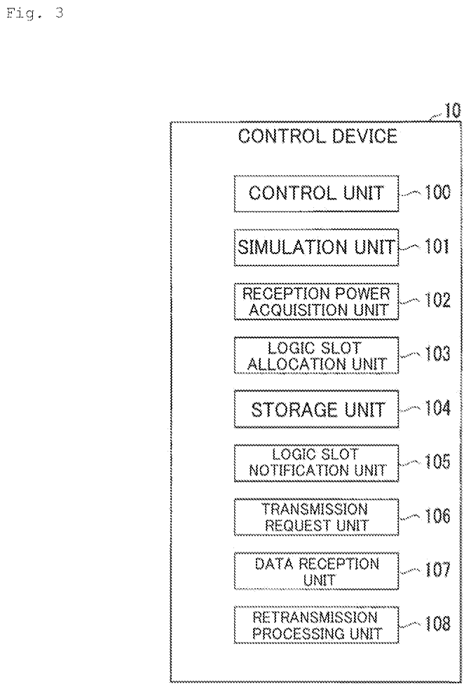

Hereinafter, the functional configuration of the control device 10 will be described. FIG. 3 is a block diagram showing the functional configuration of the control device 10 according to the first embodiment of the present invention Only functional blocks that are related to the present embodiment are shown in FIG. 3. The control device 10 is a communication control device that controls the transmission timing of uplink communication in each terminal 20. This transmission timing is, for example, the transmission timing of data transmitted by the terminals 20 to the control device 10 via a base- station 30. As described above, the control device 10 is an information processing device such as a general-purpose computer. As shown in FIG. 3, the control device 10 includes a control unit 100, a simulation unit 101, a reception power acquisition unit. 102, a logic slot allocation unit 103, a storage unit 104, a logic slot notification unit 105, a transmission request unit 106, a data reception unit 107, and a retransmission processing unit 108.

The control unit 100 controls operations of the functional units included in the control device 10. For example, the control unit 100 includes a processor such as a CPU (Central Processing Unit). Note that the functional units included in the control device 10 are realized by the processor of the control unit 100 reading and executing a software program stored in the storage unit 104, for example.

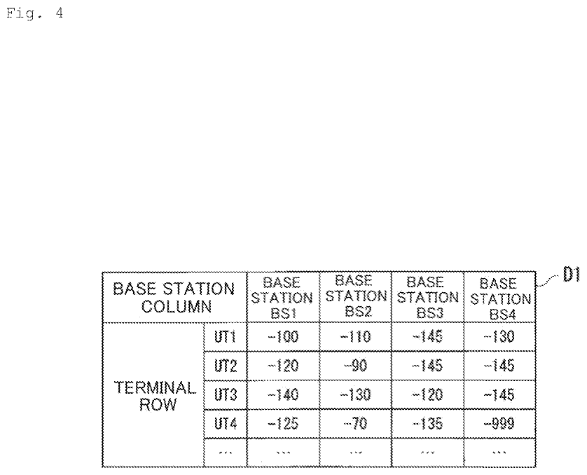

Using radio wave propagation simulation, the simulation unit 101 calculates values that indicate the strength of the reception power that reaches the base stations 30 when the terminals 20 perform uplink communication. The simulation unit 101 records the calculated. result in a later-described reception power value holding table D1 shown in FIG. 4. The reception power value holding table D1 is data that records values that indicate the strength of the reception power that reaches the base stations 30 when the terminals 20 perform uplink communication.

The reception power acquisition unit 102 acquires, from the base stations 30 that have received uplink communication, values that indicate the strength of the reception power measured by the base stations 30 when the terminals 20 perform uplink communication, and records the values in a reception power value holding table D1. The values acquired by the reception power acquisition unit 102 have priority over the values calculated by the simulation unit 101.

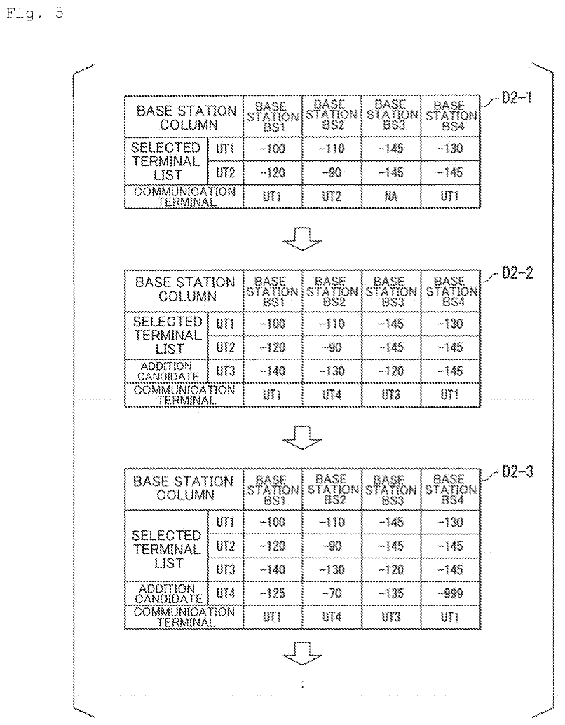

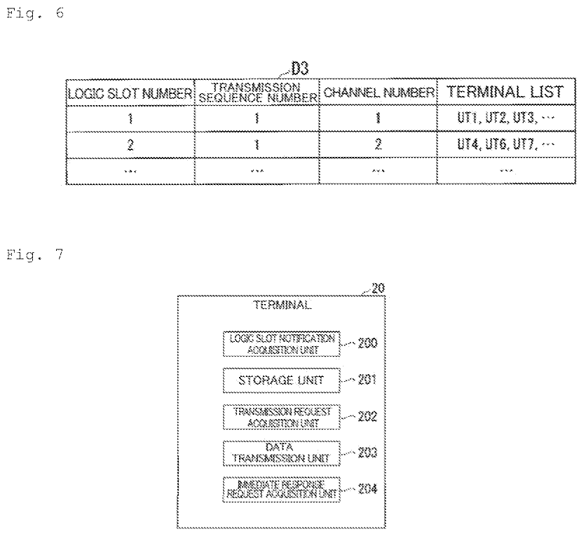

The logic slot allocation unit 103 allocates a set of terminals 20 to each logic slot such that each terminal. 20 has at least one receiving base station The receiving base station is the base station 30 that receives uplink communication from the corresponding terminal 20. The receiving base station of a terminal 20 can normally receive the uplink communication from that terminal 20. The logic slot allocation unit 103 uses a later-described transmission sequence calculation table D2 shown in FIG. 5 when performing this allocation The transmission sequence calculation table D2 is data that records terminals 20 selected as a target for the allocation of one logic slot and terminals 20 selected as selection candidates, and the strength of the reception power at the base stations 30 for uplink communication from those terminals 20. Also, the logic slot allocation unit 103 creates a logic slot holding table D3 shown in FIG. 6, which will be described later, by associating each logic slot with one transmission sequence number for one channel. The logic slot holding table D3 shows a pair of one transmission sequence number and one channel number as well as a list of terminals 20 allocated to each logic slot. The transmission sequence number is converted into a transmission timing. The channel number is converted to the frequency of the channel used in wireless communication. The logic slots may be associated in any way as long as there is a one-to-one association with the pairs of one channel and one transmission sequence number. In other words, the logic slot is unique for each pair of one channel and one transmission sequence number. For example, if the total number of available channels is N, association may be performed such that the channel number is the remainder when the logic slot number is divided by N, and the transmission sequence number is the quotient of division by N.

The storage unit 104 stores the reception power value holding table D1, the transmission sequence calculation table D2, and the logic slot holding table D3. The logic slot notification unit 105 notifies each terminal 20 of the logic slot (a pair of one channel and one transmission sequence number) that was allocated to the terminal 20 and a multicast address. The transmission request unit 106 multicasts a packet transmission request to the multicast address. The data reception unit 107 receives packets transmitted by the terminals 20 in response to the packet transmission request, and acquires the data included in the received packets. The retransmission processing unit 108 calculates a transmission sequence for a set of terminals 20 that did not respond to the packet transmission request. The retransmission processing unit 108 transmits an immediate response request notification to the terminals 20 by unicast in accordance with the calculated transmission sequence.

[Configuration of Reception Power Value Holding Table]

An example of the configuration of the reception power value holding table D1 will be described below. FIG. 4 a diagram showing the configuration of the reception power value holding table D1 stored in the storage unit 104 of the control device 10 according to the first embodiment of the present invention. As shown in FIG. 4, the reception power value holding table D1 is a tabular data structure made up of base station columns and terminal rows.

The identifiers of base stations 30 are registered as base station column names, which are the column names of base station columns, at the time of initial setting for example. The identifiers of terminals 20 are registered as terminal row names, which are the row names of terminal rows, in a terminal registration step described later. The value recorded in each cell is a value that indicates the strength of radio waves when the terminal 20 indicated by the terminal row name that corresponds to the row of that cell transmits uplink communication and that uplink communication reaches the base station 30 indicated by the base station column name that corresponds to the column of that cell. The reception power value is used as the value that indicates the strength of the radio waves. For example, the cell value is a reception power value in units of dBm.

[Configuration of Transmission Sequence Calculation Table]

Examples of the configuration of the transmission sequence calculation table D2 will be described below. FIG. 5 is a diagram showing the configuration of the transmission sequence calculation table D2 stored in the storage unit 104 of the control device 10 according to the first embodiment of the present invention As shown in FIG. 5, the transmission sequence calculation table 12 is a tabular data structure made up of base station columns, selected terminal list rows, an additional candidate row, and a communication terminal row, FIG. 5 shows transmission sequence calculation tables D2-1, D2-2, and D2-3 as three setting examples of the transmission sequence calculation table D.

The identifiers of base stations 30 are registered as base station column names, which are the column names of base station columns, at the time of initial setting for example. In logic slot calculation processing described later, the identifiers of terminals 20 that were determined to be selected as a target to be allocated the same logic slot are registered in the row names of the rows of selected terminal list rows. In logic slot calculation processing described later, the identifiers of a terminal 20 temporarily saved as a candidate for addition to a set of terminals 20 to which the same logic slot is allocated is registered in the row name of the additional candidate row.

The value recorded in each cell of a selected terminal list row is a value that indicates the strength of radio waves when the terminal 20 indicated by the terminal row name that corresponds to the row of that cell transmits uplink communication and that uplink communication reaches the base station 30 indicated by the base station column name that corresponds to the column of that cell. The reception power value is used as the value that indicates the strength of the radio waves. For example, the cell value is a reception power value in units of dBm. Note that the reception power values set in the cells of the selected terminal list rows reference the same values as the corresponding cells in the reception power value holding table D1 shown in FIG. 4.

The value recorded in each cell of an additional candidate row is a value that indicates the strength of radio waves when the terminal 20 indicated by the terminal row name that corresponds to the row of that cell transmits uplink communication and that uplink communication reaches the base station 30 indicated by the base station column name that corresponds to the column of that cell. The reception power value is used as the value that indicates the strength of the radio waves. For example, the cell value is a reception power value in units of dBm. Note that the reception power values set in the cells of the additional candidate rows reference the same values as the corresponding cells in the reception power value holding table D1 shown in FIG. 4.

The terminal name recorded in each cell of the communication terminal row is the terminal name of the terminal 20 whose uplink communication was received by the base station 30 indicated by the base station column name that corresponds to the column of that cell. Note that if there is no terminal 20 whose uplink communication was received by the base station 30 indicated by the base station column name that corresponds to the cell column, a special value “NA” indicating that fact is recorded.

[Configuration of Logic Slot Holding Table]

An example of the configuration of the logic slot holding table D3 will be described below. FIG. 6 is a diagram showing the configuration of the logic slot holding table D3 stored in the storage unit 104 of the control device 10 according to the first embodiment of the present invention As shown in FIG. 6, the logic slot holding table D3 is a tabular data structure including a logic slot number column, a transmission sequence number column, a channel number column, and a terminal list column.

A logic slot number is recorded in each cell of the logic slot number column. The logic slot numbers are, for example, ordinal numbers in order from 1. A transmission sequence number is recorded in each cell of the transmission sequence number column. The transmission sequence numbers are, for example, ordinal numbers in order from 1. Each terminal 20 uses the transmission sequence number to determine a transmission timing based on the transmission sequence. A channel number is recorded in each cell of the channel number column. The channel numbers are, for example, ordinal numbers in order from 1. Each terminal 20 replaces the channel number with the frequency of the channel used in actual wireless communication. The list registered in each cell of the terminal list is a list of identifiers of terminals 20 to which the logic slot number is allocated.

[Functional Configuration of Terminal]

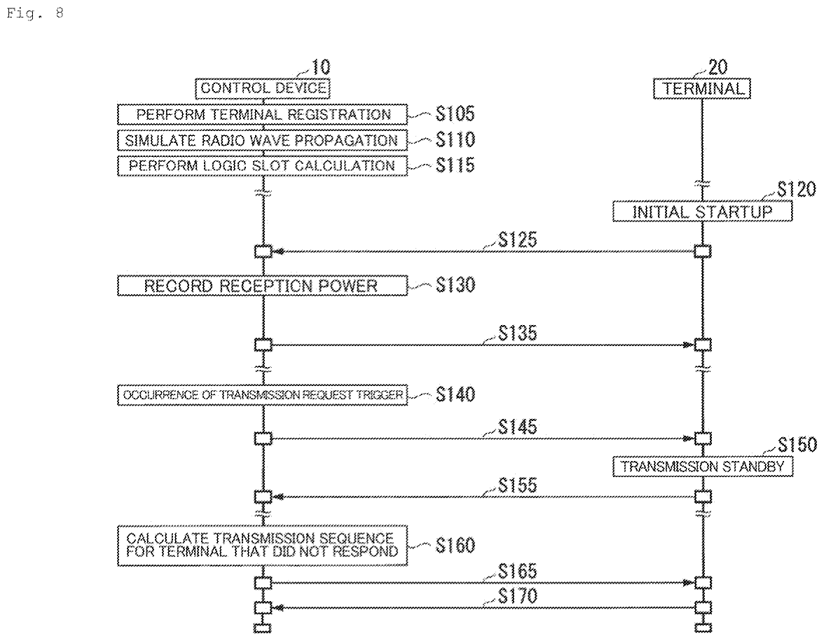

The functional configuration of the terminals 20 will be described below. FIG. 7 is a block diagram showing the functional configuration of a terminal 20 according to the first embodiment of the present invention FIG. 7 shows only the functional blocks that are related to the present embodiment. The terminal 20 is a data transmission device that pauses transmission until arrival of a transmission timing under control of the control device 10, and transmits packets to the control device 10 via a base station 30 at the transmission timing. As described above, the terminal 20 is an information processing device such as a general-purpose computer.

As shown in FIG. 7, the terminal 20 includes a logic slot notification acquisition unit 200, a storage unit 201, a transmission request acquisition unit 202, a data transmission unit 203, and an immediate response request acquisition unit 204.

The logic slot notification acquisition unit 200 acquires a notification of a logic slot (a set of one channel and one transmission sequence number) allocated to the terminal 20 and a multicast address from the control device 10. The logic slot notification acquisition unit 200 records the acquired logic slot and multicast address in the storage unit 201. The storage unit 201 stores the logic slot and the multicast address.

The transmission request acquisition unit 202 acquires a packet transmission request that was multicast to the multicast address. When the transmission request acquisition unit 202 acquires the packet transmission request, the data transmission unit 203 waits until arrival of the transmission timing calculated based on the transmission sequence number recorded in the storage unit 201. When the transmission timing arrives, the data transmission unit 203 transmits a packet set with terminal data to the control device 10 using the channel recorded in the storage unit 201. The terminal data is information that is held by the terminal 20 and is to be notified to the control device 10. The terminal data is an example of data transmitted by the terminal 20 to another device. Upon receiving the immediate response request notification, the immediate response request acquisition unit 204 immediately transmits the packet set with terminal data in an immediate response step that will be described later.

[Operation Flow of Wireless Communication System]

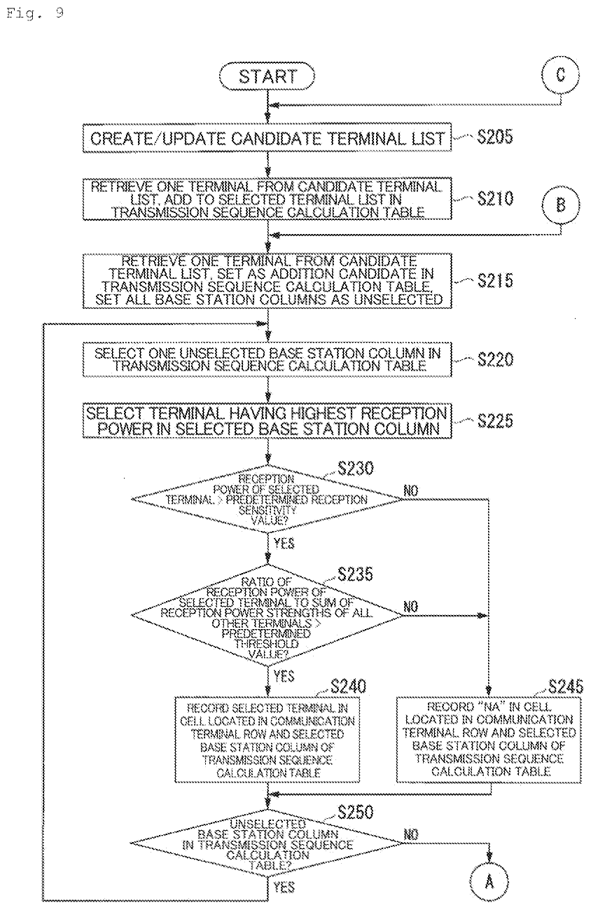

Hereinafter, an example of the operation flow of the wireless communication system 1 will be described. FIG. 8 is a sequence diagram showing the operation flow of the wireless communication system 1 according to the first embodiment of the present invention As shown in FIG. 8, first, the control unit 100 of the control device 10 executes a terminal registration step (step S105). In the terminal registration step, the control unit 100 registers a set of terminals 20 in the terminal row names of the reception power value holding table D1. At this time, the control unit 100 records an initial value as the values in the cells of the base station columns. The initial value is a value indicating “−999” or “−∞”, for example.

Next, the simulation unit 101 of the control device 10 executes a radio wave propagation simulation step (step S110). In the radio wave propagation simulation step, the simulation unit 101 performs radio wave propagation simulation for the set of terminals 20 that were registered in the terminal registration step of step S105. In this radio wave propagation simulation, the simulation unit 101 calculates the reception power of radio waves received by the base stations 30 when the terminals 20 perform uplink communication based on the geographical relationship between the installation locations of the terminals 20 and the base stations 30. The simulation unit 101 records the calculated reception power values in the reception power value holding table D1. The radio wave propagation simulation step is performed using existing technology. For example, an existing radio wave propagation simulation tool can be used. For example, a configuration is possible in which a list of installation position information of the base stations 30, installation position information of the terminals 20, and transmission power values is created in advance, and the list is input to a radio wave propagation simulation tool (e.g., DB (database)).

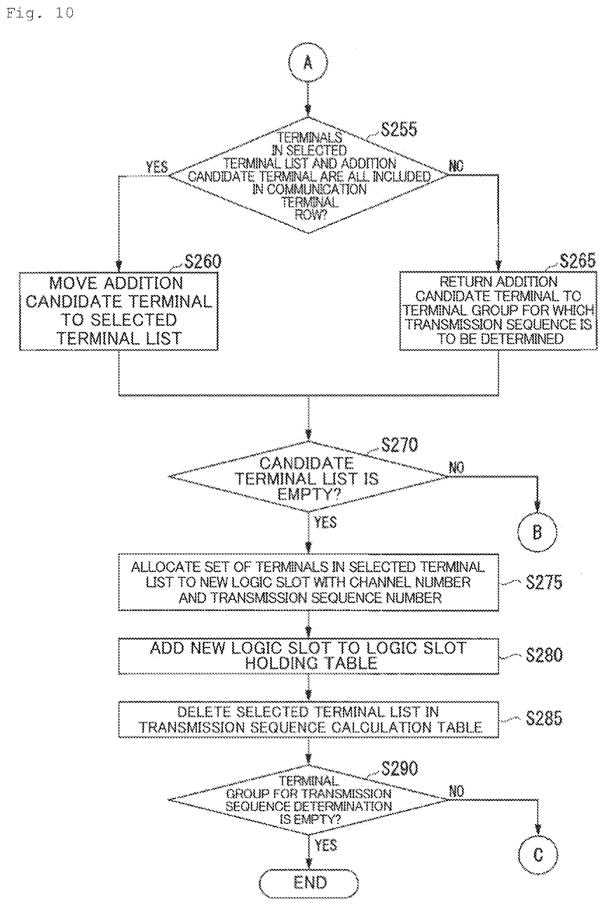

Next, the logic slot allocation unit 103 of the control device 10 executes a logic slot calculation step (step S115). In the logic slot calculation step, the logic slot allocation unit 103 calculates logic slots using the transmission sequence calculation table D2, and records the calculated set of logic slots in the logic slot holding table D3. Note that the method. of calculating the logic slots will be described in detail later with reference to FIG. 9.

Thereafter, each terminal 20 performs initial startup (step S120). After the initial startup, the terminal 20 executes a logic slot notification acquisition step (step S125). In the logic slot. notification acquisition step, the logic slot notification acquisition unit 200 of the terminal 20 attempts to acquire logic slot information regarding the terminal 20 from the control device 10 via a base station 30 (not shown). For example, the logic slot notification acquisition unit 200 transmits a signal requesting the logic slot notification to the control device 10 by uplink communication.

When the control unit 100 of the, control device 10 receives the uplink communication transmitted by the terminal 20 in the logic slot notification acquisition step, the control unit 100 executes a reception power recording step (step S130). In the reception power recording step, the control unit 100 receives information regarding the base station 30 that received the uplink communication transmitted. by the terminal 20 in the logic slot notification acquisition step of step S125, and the reception power value of the uplink communication at the base station 30, and records the received information in The reception power value holding table D1. The reception power acquisition unit 102 of the control device 10 retrieves the reception power value notified together with the uplink communication by the base station 30, and the control unit 100 acquires the reception power value that was retrieved by the reception power: acquisition unit 102.

Subsequently, the logic slot notification unit 105 of the control device 10 executes a logic slot notification step (step S135). In the logic slot notification step, the logic slot notification unit 105 transmits, to the terminal 20, a logic slot notification that includes a multicast address, a transmission sequence number, a channel number, and a transmission interval as information elements. The logic slot notification acquisition unit 200 of the terminal 20 receives the logic slot notification transmitted by the control device 10, and records the received logic slot notification in the storage unit 201.

After that, some kind of transmission request trigger occurs in the control device 10 (step S140). For example, the trigger is the reception of an earthquake early warning or a manual operation. Accordingly, the transmission request unit 106 of the control device 10 performs a transmission request notification step (step S145). In the transmission request notification step, the transmission request unit 106 multicast a transmission request notification to the multicast address. Note that the multicast address is the same as the multicast address that was notified to the terminal 20 by the logic slot notification in the logic slot notification step of step S135.

When the transmission request acquisition unit 202 of the terminal 20 receives the transmission request notification that was transmitted in the transmission request notification step of step S145 with the multicast address stored in the storage unit 201, the transmission request acquisition unit 202 executes a transmission standby step (step S150). In the transmission standby step, the transmission request acquisition unit 202 waits for transmission until arrival of the transmission timing indicated by the transmission sequence number that was acquired from the logic slot notification. The time indicated by the transmission sequence number is, for example, a time obtained by adding the product of the transmission sequence number and the transmission interval to the start point time, which is the time when the terminal 20 received the transmission request notification.

When the transmission standby is complete, the data transmission unit 203 of the terminal 20 executes a transmission request response step based on the transmission sequence number acquired from the logic slot notification (step S155). In the transmission request response step, the data transmission unit 203 transmits the terminal data held by the terminal 20 to the control device 10 by uplink communication at the transmission timing indicated by the transmission sequence number. The data reception unit 107 of the control device 10 receives the terminal data transmitted by the terminal 20 as a transmission request response to the transmission request notification.

After that, the retransmission processing unit 108 of the control device 10 performs a transmission sequence calculation step (step S160). In the transmission sequence calculation step, the retransmission processing unit 108 extracts a terminal 20 from which the data reception unit 107 has not received a transmission request response in response to the transmission request. The retransmission processing unit 108 calculates a transmission sequence that is to be allocated to the extracted terminals 20.

The retransmission processing unit 108 of the control device 10 executes the immediate response request notification step (step S165). In the immediate response request notification step, the retransmission processing unit 108 unicasts an immediate response request notification to each of the terminals 20 from which the data reception unit 107 has not received the transmission request response, in accordance with the transmission sequence that was calculated in step S160. Upon receiving the immediate response request notification, the immediate response request acquisition unit 204 of the terminal 20 executes an immediate response step (step S170). In the immediate response step, the immediate response request acquisition unit 204 immediately transmits the terminal data to the control device 10 by uplink communication.

[Flow of Logic Slot Calculation Processing of Control Device]

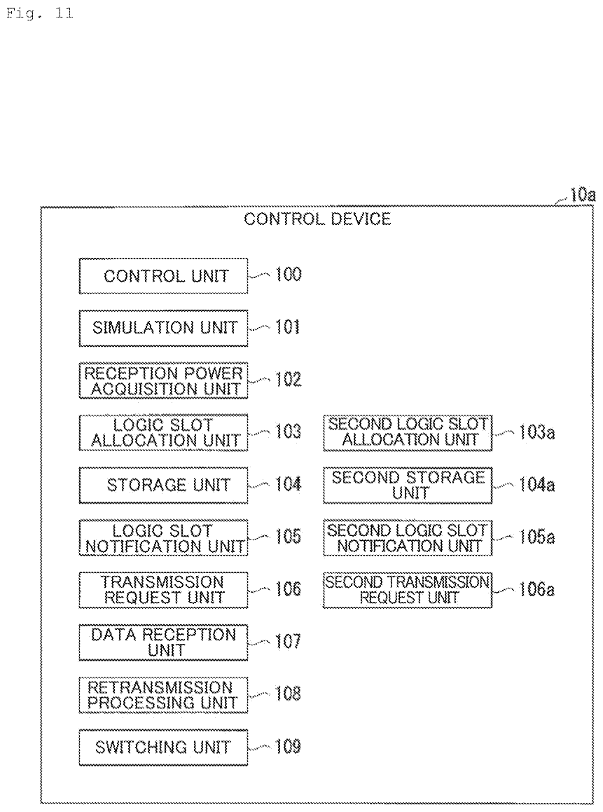

Hereinafter, an example of a detailed processing flow of the logic slot calculation step of the control device 10 will be described. FIGS. 9 and 10 are flowcharts showing detailed processing operations of the logic slot calculation step performed by the logic slot allocation unit 103 of the control device 10 according to the first embodiment of the present invention.

As shown in FIG. 9, when the logic slot calculation step is started, the logic slot allocation unit 103 proceeds to step S205. In step S205, the logic slot allocation unit 103 retrieves a set of terminals for which a transmission sequence is to be determined, and creates a candidate terminal list. Here, the logic slot allocation unit 103 obtains a copy of all terminal row names recorded in the terminal rows of the reception power value holding table D1 as the candidate terminal list.

Note that in step S205, the logic slot allocation unit 103 may retrieve a subset of the terminal group, or may retrieve the whole set of all terminals 20 recorded in the reception power value holding table D1 as described above. Also, the logic slot allocation unit 103 may randomly select a fixed number of terminals from all of the terminals 20 recorded in the reception power value holding table D1 as a subset of the terminal group. Note that this fixed number is, for example, a constant multiple (e.g., two times) the number of base stations included in the wireless communication system 1. As another example, a configuration is possible in which the logic slot allocation unit 103 distributes all of the terminals 20 recorded in the reception power value holding table D1 to sets of terminals 20 having different base stations 30 with the highest reception power, and selects a fixed number of terminals or fewer (e.g., two or fewer) terminals from each set, as a subset of the terminal group. After creating the candidate terminal list, the logic slot allocation unit 103 proceeds to step S210.

In step S210, the logic slot allocation unit 103 retrieves one terminal 20 from the candidate terminal list that was created in step S205. The logic slot allocation unit 103 adds the identifier of the retrieved terminal 20 to the row name of the selected terminal list row of the transmission sequence calculation table D2. Also, for the cells of the selected terminal list row in which the identifier of the retrieved terminal 20 was added to the row name, the logic slot allocation unit 103 sets the reception power values when the base stations 30 received the uplink communication from the retrieved terminal 20. The logic slot allocation unit 103 reads the reception power values from the reception power value holding table D1. The logic slot allocation unit 103 then proceeds to step S215.

In step S215, the logic slot allocation unit 103 retrieves one terminal 20 from the candidate terminal list that was created in step S205. The logic slot allocation unit 103 sets the identifier of the retrieved terminal 20 in the row name of the additional candidate row in the transmission sequence calculation table D2. Also, the logic slot allocation unit 103 sets the reception power values when the base stations 30 received the uplink communication from the retrieved terminal 20 in the cells of the additional candidate row. The logic slot allocation unit. 103 reads the reception power values from the reception power value holding table D1. The logic slot allocation unit 103 clears the selection of all of the base station columns in the transmission sequence calculation table D2. The logic slot allocation unit 103 then proceeds to step S220.

In step S220, the logic slot allocation unit 103 selects any one unselected base station column in the transmission sequence calculation table D2. The base station column that is selected will be called the selected base station column The logic slot allocation unit 103 then proceeds to step S225.

In step S225, the logic slot allocation unit 103 selects the terminal 20 that has the highest reception power in the selected base station column. The terminal 20 that is selected will be called the selected terminal. The logic slot allocation unit 103 then proceeds to step S230.

In step S230, the logic slot allocation unit 103 determines whether or not the reception power of the selected. terminal that was selected in step S225 is greater than a predetermined reception sensitivity value. The predetermined reception sensitivity value is set to a value that is determined in advance by a wireless modulation method or the like. For example, the predetermined value is set to −131.5. The logic slot allocation unit 103 proceeds to step S235 if the determination result is affirmative (step S230: YES), and proceeds to step S3245 if the determination result is negative (step S230: NO).

In step S235, the logic slot allocation unit 103 reads out the reception power strengths of all terminals 20 other than the selected terminal from the selected base station column in the transmission sequence calculation table D2, and calculates the sum of the read reception power strengths. In the present embodiment, the reception power value is used as the reception power strength. The logic slot allocation unit 103 determines whether or not the ratio of the reception power of the selected terminal to the calculated sum of the reception power strengths is larger than a specified threshold value. The threshold value used for the determination is set to a value that has been determined in advance according to the reception performance of the base station 30, and is the value of 10, for example. The logic slot allocation unit 103 proceeds to step S240 if the determination result is affirmative (step S235: YES), and proceeds to step S245 if the determination result is negative (step S235: NO).

In step S240, the logic: slot allocation unit 103 records the selected terminal in the cell that is in the selected base station column and the communication terminal row of the transmission sequence calculation table D2. The logic slot allocation unit 103 then proceeds to step S250.

In step S245, the logic slot allocation unit 103 records “NA” in the cell that is in the selected base station column and the communication terminal row of the transmission sequence calculation table D2. The logic slot allocation unit 103 then proceeds to step S250.

In step S250, the logic slot allocation unit 103 determines whether or not there is an unselected base station column in the transmission sequence calculation table D2. The logic slot allocation unit 103 proceeds to step S220 if the determination result is affirmative (step S250: YES), and proceeds to step S255 in FIG. 10 if the determination result is negative (step S250: NO).

In step S255 of FIG. 10, the logic slot allocation unit 103 references the transmission sequence calculation table D2 and determines whether or not the terminals 20 in the selected terminal list row and the terminal 20 in the additional candidate row are all included in the communication terminal row. The logic slot allocation unit 103 proceeds to step S260 if the determination result is affirmative (step S255: YES), and proceeds to step S265 if the determination result is negative (step S255: NO).

In step S260, the logic: slot allocation unit 103 moves the terminal 20 in the additional candidate row of the transmission sequence calculation table D2 to the selected terminal list row. The logic slot allocation unit 103 then proceeds to step S270.

In step S265, the logic slot allocation unit 103 returns the terminal 20 in the additional candidate row of the transmission sequence calculation table D1 to the terminal group for which the transmission sequence is to be determined. The logic slot allocation unit 103 then proceeds to step S270.

In step S270, the logic slot allocation unit 103 determines whether or not the candidate terminal list is empty. The logic slot allocation unit. 103 proceeds to step S275 if the determination result is affirmative (step S270: YES), and proceeds to step S215 of FIG. 9 if the determination result is negative (step S270: NO).

In step S275, the logic slot allocation unit 103 allocates the set of terminals 20 in the selected terminal list of the transmission sequence calculation table D2 to a new logic slot, and furthermore allocates one transmission sequence number of one channel number. In step S280, the logic slot allocation unit 103 records the logic slot number, the transmission sequence number, the channel number, and the terminal list for the new logic slot in the logic slot holding table D3. In step S285, the logic slot allocation unit 103 deletes the selected terminal list in the transmission sequence calculation table D2. The logic slot allocation unit 103 then proceeds to step S290.

Note that in step S275, the logic slot allocation unit 103 allocates the same logic slot to all of the terminals 20 in the selected terminal list. In step S280, the logic slot allocation unit 103 allocates the same channel number and the same transmission sequence number to the terminals 20 to which the same logic slot was allocated. In other words, there is a one-to-one relationship between the logic slots and the sets of one channel number and one transmission number.

In step S290, the logic slot allocation unit 103 determines whether or not the terminal group for which the transmission sequence is to be determined is empty. The logic slot allocation unit 103 proceeds to the end if the determination result is affirmative (step S290: YES), and proceeds to step S205 in FIG. 9 if the determination result is negative (step S290: NO).

The processing of FIGS. 9 and 10 will be described with reference to FIG. 5. In the following, the terminals 20 having the identifiers UT1, UT2, UT3, UT4, and so on will be called the terminal UT1, the terminal UT2, the terminal UT3, the terminal UT4, and so on Also, the base stations 30 having the identifiers BS1, BS2, BS3, and BS-1 will be called the base station BS1, the base station BS2, the base station BS3, and the base station BS4. The candidate terminal list that was created or updated in step S205 includes the terminal UT1, the terminal UT2, the terminal UT3, the terminal UT14, the terminal UT5, and so on. In the initial state, no terminal 20 is set in the selected terminal list of the transmission sequence calculation table D2. In the transmission sequence calculation table D2-1 shown in FIG. 5, the terminal UT1 that was selected in step S210 and recorded and the terminal UT2 that was selected in step S215 and recorded in step S240 are set as row names in the selected terminal list. The reception power values of uplink communication from the terminal UTI and the terminal UT2 at the base stations BS1 to BS4 are set in the rows of the selected terminal list.

The logic slot allocation unit 103 adds an additional candidate row to the transmission sequence calculation table D2-1, and sets the terminal UT3 selected from the candidate terminal list as the row name of the additional candidate row. The logic slot allocation unit 103 sets the reception power values of uplink communication from the terminal UT3 at the base stations BS1 to BS4 in the cells of the additional candidate row (step S215).

The logic slot allocation unit 103 first selects the base station BS1 column (step S220). From among the terminal UT1, the terminal UT2, and the terminal UT3, the logic slot allocation unit 103 selects the terminal UT1 that has the highest reception power value at the base station BS1 (step S225). The logic slot allocation unit 103 determines that the reception power value of the terminal UT1 at the base station BS1 is greater than equal to the predetermined reception sensitivity value (step S230: YES). Also, the logic slot allocation unit 103 determines that [reception power value of uplink communication from terminal UT1 at base station BS1]/[reception power value of uplink communication from terminal UT2 at base station BS1+reception power value of uplink communication from terminal UT2 at base station BS1] is greater than or equal to the specified threshold value (step S235: YES). Accordingly, the logic slot allocation unit 103 sets the terminal UTI as the communication terminal in the base station BS1 column (step S240).

Next, the logic slot allocation unit 103 selects the base station BS2 column (step S250: YES, step S220). From among the terminal UT1, the terminal UT2, and the terminal UT3, the logic slot allocation unit 103 selects the terminal UT2 that has the highest reception power value at the base station BS2 (step S225). The logic slot allocation unit 103 determines that the reception power value of the terminal UT2 at the base station BS2 is greater than equal to the predetermined reception sensitivity value (step S230: YES). Also, the logic slot allocation unit 103 determines that [reception power value of uplink communication from terminal UT2 at base station BS2]/[reception power value of uplink communication from terminal UTI at base station BS2+reception power value of uplink communication from terminal UT3 at base station BS2] is greater than or equal to the specified threshold value (step S235: YES). Accordingly, the logic slot allocation unit 103 sets the terminal UT2 as the communication terminal in the base station BS2 column (step S240).

Next, the logic slot allocation unit 103 selects the base station on BS3 column (step S250: YES, step S220). From among the terminal UT1, the terminal UT2, and the terminal UT3, the logic slot allocation unit 103 selects the terminal UT3 that has the highest reception power value at the base station BS3 (step S225). The logic slot allocation unit 103 determines that the reception power value of the terminal UT3 at the base station BS3 is greater than equal to the predetermined reception sensitivity value (step S230: YES). Also, the logic slot allocation unit 103 determines that [reception power value of uplink communication from terminal UT3 at base station BS3]/[reception power value of uplink communication from terminal UT1 at base station BS3+reception power value of uplink communication from terminal UT2 at base station BS3] is greater than or equal to the specified threshold value (step S235: YES). Accordingly, the logic slot allocation unit 103 sets the terminal UT3 as the communication terminal in the base station BS3 column (step S240).

Next, the logic slot allocation unit 103 selects the base station BS4 column (step S250: YES, step S220). From among the terminal UT1, the terminal UT2, and the terminal UT3, the logic slot allocation unit 103 selects the terminal UT1 that has the highest reception power value at the base station BS4 (step S225). The logic slot allocation unit 103 determines that the reception power value of the terminal UT1 at the base station BS4 is greater than equal to the predetermined reception sensitivity value (step S230: YES). Also, the logic slot allocation unit 103 determines that [reception power value of uplink communication from terminal UT1 at base station BS4]/[reception power value of uplink communication from terminal UT2 at base station BS4+reception power value of uplink communication from terminal UT3 at base station BS4] is greater than or equal to the specified threshold value (step S235: YES). Accordingly, the logic slot allocation unit 103 sets the terminal UT1 as the communication terminal in the base station B54 column (step S240).

When all of the base station columns have been selected. (step S250: NO), the content is set as shown in the transmission sequence calculation table D2-2. Because the terminal UT1 and the terminal UT2 in the selected terminal list row and the terminal UT3 in the additional candidate row are included in the communication terminal row of the transmission sequence calculation table D2-2 (step S255: YES), the logic slot allocation unit 103 moves the additional candidate row to the selected terminal list row (step S260).

The logic slot allocation unit 103 sets the terminal UT4 that was selected from the candidate terminal list as the row name of the additional candidate row. The logic slot allocation unit 103 sets the reception power values of uplink communication from the terminal UT4 at the base stations BS1 to BS4 in the cells of the additional candidate row (step S270: NO, step S215).

The logic slot allocation unit 103 selects the base station BS1 column (step S220). The logic slot allocation unit 103 selects the terminal UT1 having the highest reception power value at the base station BS1 (step S225). The logic slot allocation unit 103 determines YES in step S230 and step S235, and sets the terminal UT1 as the communication terminal in the base station BS1 column (step S240).

Next, the logic slot allocation unit 103 selects the base station B32 column (step S220). The logic slot allocation unit 103 selects the terminal UT4 having the highest reception power value at the base station BS2 (step S225). The logic slot allocation unit 103 determines YES in step S230 and step S235, and sets the terminal UT4 as the communication terminal in the base station BS2 column (step S240).

Next, the logic slot allocation unit 103 selects the base station BS3 column and the base station BS4 column and performs similar processing, sets the terminal UT3 as the communication terminal in the base station BS3 column, and sets the terminal UT1 as the communication terminal in the base station BS4 column (step S250: YES, steps S220 to S240). Out of the terminal UT1, the terminal UT2, and the terminal UT3 in the selected terminal list row and the terminal UT-I in the additional candidate row, the terminal UT2 is not included in the communication terminal row (step S250: NO, step S255: NO), and therefore the logic slot allocation unit 103 returns the terminal UT4 of the additional candidate row to the terminal group for which the transmission sequence is to be determined (step S5265). The logic slot allocation unit 103 selects the terminal UT5 from the candidate terminal list and continues the processing (step S270: NO, step S215).

When the processing for the entirety of the candidate terminal list has ended, the logic slot allocation unit 103 allocates a logic slot to the set of terminals 20 that have been set in the selected terminal list row of the transmission sequence calculation table D2, and furthermore allocates any one transmission sequence number of any one channel number (step S270: YES, step S275). The receiving base station of the terminal 20 indicated by each cell in the communication terminal row of the transmission sequence calculation table D2 is the base station 30 indicated by the base station column name that corresponds to the column of that cell.

Due to having the above-described configuration, the control device 10 according to the first embodiment can avoid the case where uplink communication attempts from terminals 20 interfere with each other at a plurality of base stations 30 as shown in FIG. 2. Accordingly, the control device 10 can shorten the time required to collect terminal data from a large number of terminals 20 at the same time.

### Second Embodiment

Hereinafter, a second embodiment of the present invention will be described with reference to the drawings. When the first embodiment described above operates, the transmission sequence may need to be reconfigured due to the addition of a terminal, for example. However, if the transmission sequence is reconfigured and a transmission request trigger occurs while the terminals are being notified of the updated transmission sequence, the transmission sequence number setting will be different between the group of terminals that have not been updated and the group of terminals that have been updated. Accordingly, interference will frequently occur between terminals that have the same transmission sequence number in their settings. The second embodiment was achieved in consideration of such circumstances and supplements the first embodiment. Hereinafter, the second embodiment will be described with a focus on differences from the first embodiment.

[Configuration of Wireless Communication System]

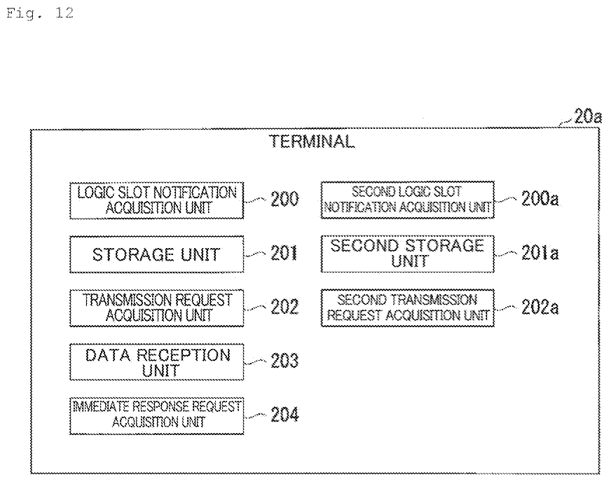

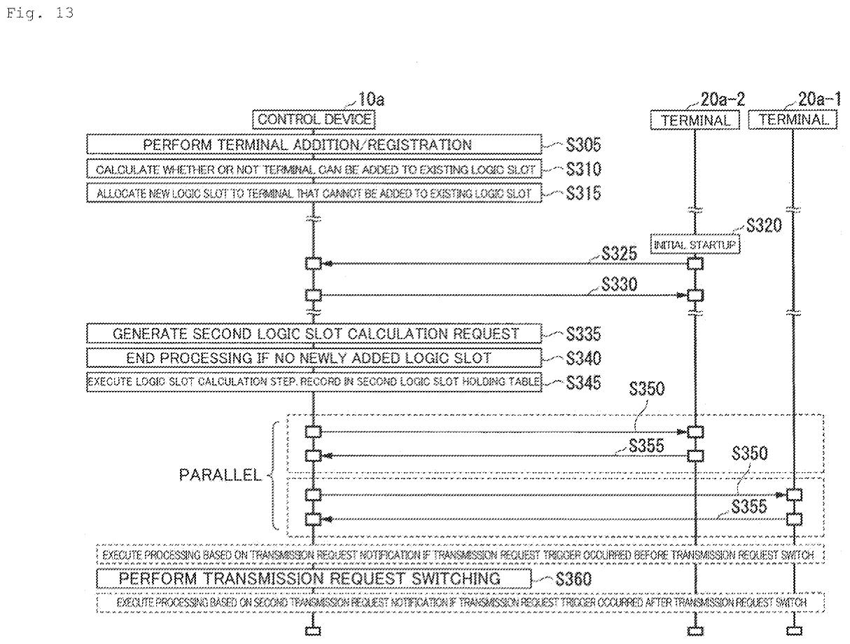

Hereinafter, the configuration of a wireless communication system 1a will be described. The wireless communication system 1a according to the second embodiment of the present invention has the same configuration as the wireless communication system 1 of the first embodiment, with the exceptions of including a control device 10a shown in FIG. 11 instead of the control device 10 of the wireless communication system 1 of the first embodiment shown in FIG. 1, and including terminals 20a shown in FIG. 12 instead of the terminals 20 of the wireless communication system 1.

[Functional Configuration of Control Device 10a]

The functional configuration of the control device 10a will be described below. FIG. 11 is a block diagram showing the functional configuration of the control device 10a according to the second embodiment of the present invention In the control device 10a shown in FIG. 11, portions the same as those of the control device 10 according to the first embodiment shown in FIG. 3 are designated by the same reference numerals, and the description thereof will be omitted. The control device 10a shown in FIG. 11 differs from the control device 10 of the first embodiment shown in FIG. 3 in that a second logic slot allocation unit 103a, a second storage unit 104a, a second logic slot notification unit 105a, a second transmission request unit 106a, and a switching unit 109 are provided in addition to the functional blocks of the control device 10.

The second logic slot allocation unit 103a is a functional block that has functions similar to those of the logic slot allocation unit 103. The transmission sequence calculation table D2 used by the second logic slot allocation unit 103a will be called a second transmission sequence calculation table D2a, and the logic slot holding table D3 generated by the second logic slot allocation unit 103a will be called a second logic slot holding table D3a. Also, the logic slot to which the second logic slot allocation unit 103a allocates a set of terminals 20a will be called a second logic slot, and the channel and the transmission sequence number that are associated with the second logic slot will be called the second channel and the second transmission sequence number.

The second storage unit 104a is a functional block that has functions similar to those of the storage unit 104. The second storage unit 104a stores a second reception power value holding table D1a, a second transmission sequence calculation table D2a, and a second logic slot holding table D3a. The second reception power value holding table D1a, the second transmission sequence calculation table D2a, and the second logic slot holding table D3a are data structures that are respectively similar to the reception power value holding table D1, the transmission sequence calculation table D2, and the logic slot holding table D3.

The second logic slot notification unit 105a is a functional block that has functions similar to those of the logic slot notification unit 105. The logic slot notification unit 105 notifies each terminal 20a of the second logic slot (a set of one second channel and one second transmission sequence number) that was allocated to the terminal 20a and a second multicast address. The second transmission request unit 106a is a functional block that has functions similar to those of the transmission request unit 106. The second transmission request unit 106a multicasts a packet transmission request to the second multicast address. The switching unit 109 has a function by which the functional block that transmits a packet transmission request is switched between the transmission request unit 106 and the second transmission request unit 106a.

[Functional Configuration of Terminal]

The functional configuration of the terminals 20a will be described below. FIG. 12 is a block diagram showing the functional configuration of a terminal 20a according to the second embodiment of the present invention. In the terminal 20a shown in FIG. 12, portions the same as those of the terminal 20 according to the first embodiment shown in FIG. 7 are designated by the same reference numerals, and the description thereof will be omitted. The terminal 20a shown in FIG. 11 differs from the terminal 20 of the first embodiment shown in FIG. 7 in that the terminal 20a includes a second logic slot notification acquisition unit 200a, a second storage unit 201a, and a second transmission request acquisition unit 202a in addition to the functional blocks of the terminal 20.

The second logic slot notification acquisition unit 200a is a functional block that has functions similar to those of the logic slot notification acquisition unit 200. The second logic slot notification acquisition unit 200a acquires, from the control device 10a, a notification of the second logic slot (a set of one second channel and one second transmission sequence number) that was allocated to the terminal 20a and the second multicast address. The second storage unit 201a is a functional block that has functions similar to those of the storage unit 201. The second storage unit 201a stores the second logic slot and the second multicast address. The second transmission request acquisition unit 202a is a functional block that has functions similar to those of the transmission request acquisition unit 202. The second transmission request acquisition unit 202a acquires the packet transmission request that was multicast to the second multicast address.

[Operation Flow of Wireless Communication System]

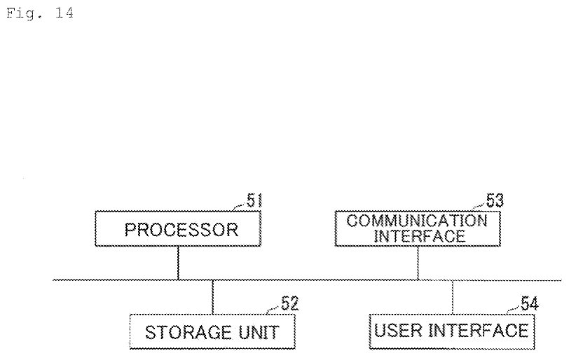

Hereinafter, an example of the operation flow of the wireless communication system 1a will be described. FIG. 13 is a sequence diagram showing the operation flow of the wireless communication system 1a according to the second embodiment of the present invention Note that descriptions will not be given for operations that are same as those of the, wireless communication system 1.

Before the start of the sequence of FIG. 13, it is assumed that processing from the terminal registration step of step S105 to the logic slot notification step of step S135 in FIG. 8 has been performed by the control device 10a and the terminal 20a. Before the start of the sequence of FIG. 13, it is assumed that a terminal 20a-1 is a terminal 20a for which logic slot information has been acquired in the logic slot notification step of step S135, and a terminal 20a-2 is a terminal 20a that is to be additionally registered thereafter.

As shown in FIG. 13, first, the control device 10a performs a terminal addition/registration step (step S305). In the terminal addition/registration step, the control unit 100 of the control device 10a adds the terminal 20a-2 to the second. reception power value holding table D1a. Also, the simulation unit 101 uses radio wave propagation simulation to calculate values that indicate she reception power strength at the base stations 30 when the additionally registered terminal 20a performs uplink communication, and records the calculated values in the reception power value holding table D1.

The logic slot allocation an it 103 determines whether the terminal 20a-2 can be added to any of the existing logic slots (step S310). The logic slot allocation unit 103 determines whether the terminal 20a-2 can be added to one of the existing logic slots as follows. Specifically, the logic slot allocation unit 103 records all of the terminals 20a that have been allocated to a determination target log slot in the selected terminal list row of the transmission sequence calculation table D2, and records the terminal 20a-2 in the additional candidate row of the transmission sequence calculation table D2. After this recording, the logic slot allocation unit 103 executes processing similar to that from step S220 of FIG. 9 to step S255 of FIG. 10. If the determination result in step S255 is affirmative (step S255: YES), the logic slot allocation unit 103 determines that the terminal 20a-2 can be added to the determination target logic slot. On the other hand, if the determination result in step S255 is negative (step S5255: NO), the logic slot allocation unit 103 determines that the terminal 20a-2 cannot be added to the determination target logic slot.

Based on this determination result, the logic slot allocation unit. 103 allocates a new logic slot to the terminal 20a-2 if it cannot be added to any of the existing logic slots (step S315). Note that if there are a plurality of terminals 20a-2 that cannot be added to any of the existing logic slots, the logic slot allocation unit 103 performs the following processing. Specifically, the logic slot allocation unit 103 creates a candidate terminal list in which the terminal group made up of a plurality of terminals 20a-2 that cannot be added to any of the existing logic slots is a subset of the terminal group for which the transmission sequence is to be determined. The logic slot allocation unit 103 executes processing from step S205 of FIG. 9 to step S290 of FIG. 10 for the created. candidate terminal list. Accordingly, the logic slot allocation unit 103 newly allocates any one new logic slot and any one transmission sequence number of any one channel number to the terminals in the terminal group made up of a plurality of terminals 20a-2 that cannot be added to any of the existing logic slots. On the other hand, if there is only one terminal 20a-2 that cannot be added to any of the existing logic slots, the logic slot allocation unit 103 newly allocates one new logic slot and any one transmission sequence number of any one channel number to the one terminal 20a-2.

If the terminal 20a-2 performs initial startup at a time that is after the above processing but before the calculation of the second logic slot is performed (step S320), the terminal 20a-2 executes the logic slot notification acquisition step (step S325). In the logic slot notification acquisition step, the logic slot notification acquisition unit 200 of the terminal 20a-2 attempts to acquire logic slot. information regarding the terminal 20a-2 from the control device 10a via a base station 30 (not shown). For example, the second logic slot notification acquisition unit 200a of the terminal 20a-2 transmits a signal requesting the logic slot notification to the control device 10a by uplink communication.

When the control device 10a receives the uplink communication transmitted by the terminal 20a-2 in the logic slot notification acquisition step, the control device 10a performs processing similar to that of the reception power recording step in step S130 shown in FIG. 8. Specifically, the control unit 100 of the control device 10a receives the identifier of the base station 30 that received the uplink communication and the reception power value of the uplink communication at that base station 30, and records the received information in the reception power value holding table D1 stored in the storage unit 104.

Subsequently, the logic slot notification unit 105 of the control device 10a executes the logic slot notification step (step S330). In the logic slot notification step, the logic slot notification unit 105 transmits, to the terminal 20a-2, a logic slot notification that includes a multicast address, a transmission sequence number, a channel number, and a transmission interval as constituent elements. The logic slot notification acquisition unit 200 of the terminal 20a-2 receives the logic slot notification transmitted by the control device 10a, and records the received logic slot notification in the storage unit 201.

After that, a second logic slot calculation request is generated in the control device 10a (step S5335). The second logic slot calculation request is generated by a manual operation, for example. If the control unit 100 of the control device 10a has determined that no terminal has been newly added to a logic slot in the steps up to this point, the processing ends, and the subsequent steps are not executed (step S340).

On the other hand, if the control unit 100 has determined that a terminal has been newly added to a logic slot, the control unit 100 copies the reception power value holding table D1 stored in the storage unit 104 and stores the copy as the second reception power value holding table D1a in the second storage unit 104a. The control unit 100 instructs the second logic slot allocation unit 103a to execute the logic slot calculation step. Using the second reception power value holding table D1a and the second transmission sequence calculation table D2a in place of the reception power value holding table D1 and the transmission sequence calculation table D2, the second logic slot allocation unit 103a executes the logic slot calculation step likewise to step S115 of FIG. 6. The second logic slot allocation unit 103a records the calculated set of second logic slots in the second logic slot holding table D3a. The second storage unit 201a stores the second logic slot holding table D3a (step S345).

Next, the control device 10a executes a second logic slot notification step using unicast (step S350). In the second logic slot notification step, the second logic slot notification unit 105a of the control device 10a notifies, by unicast, the terminal 20a-1 and the terminal 20a-2 of a second logic slot notification in which the second logic slot (second transmission sequence number and second channel number) recorded in the second logic slot holding table D3a, the second multicast address, and the second transmission interval are included as information elements. In both the terminal 20a-1 and the terminal 20a-2, the second logic slot notification acquisition unit 200a receives the second logic slot notification transmitted by the control device 10a, and records the received second logic slot notification in the second storage unit 201a. The second logic slot notification acquisition units 200a of the terminal 20a-1 and the terminal 20a-2 return a response to the control device 10a by uplink communication (step S355).

Then, when the second logic slot notification unit 105a of the control device 10a has received a response from all terminals 20a-1 and all terminals 20a-2, the switching unit 109 executes a transmission request switching step (step S360). The switching unit 109 performs switching such that the functional block that transmits the transmission request is switched from the transmission request unit 106 to the second. transmission request unit 106a.

Note that if a transmission request trigger occurs before the transmission request switching step of step S360 is complete in the control device 10a, the transmission request unit 106 performs the transmission request notification step of step S145 shown in FIG. 8 and multicasts a transmission request notification to the multicast address. This multicast address is the same as the one notified to the terminal 20a-1 in the logic slot notification step of step S135 and the one notified to the terminal 20a-2 in the logic slot notification step of step S330. When the transmission request acquisition unit 202 of the terminal 20a-1 or the terminal 20a-2 receives the transmission request notification at the multicast address, the transmission standby step of step S150 shown in FIG. 8 is performed, and transmission is paused until arrival of the transmission timing indicated by the transmission sequence number acquired from the logic slot notification. Note that the time indicated by the transmission sequence number is, for example, a time obtained by adding the product of the transmission sequence number and the transmission interval to the start point time, which is the time when the terminal 20a received the transmission request notification When the transmission standby ends, the data transmission unit 203 of the terminal 20a-1 or 20a-2 performs the transmission request response step of step S155 shown in FIG. 8 and transmits terminal data to the control device 10a by uplink communication.

On the other hand, if the transmission request trigger occurs after the transmission request switching step of step S360 is complete in the control device 10a, the second transmission request unit 106a performs the transmission request notification step of step S145 shown in FIG. 8, and multicasts the second transmission request notification to the second multicast address. Note that the second multicast address is the same as the one notified to the terminal 20a-1 and the terminal 20a-2 in the second logic slot notification step of step S350. When the second transmission request acquisition unit 202a of the terminal 20a-1 or the terminal 20a-2 receives the second transmission request notification at the second multicast address, the transmission standby step of step S150 shown in FIG. 8 is performed, and transmission is placed on standby until arrival of the transmission timing indicated by the second transmission sequence number acquired from the second logic slot notification. Note that the time indicated by the second transmission sequence number is, for example, a time obtained by adding the product of the second transmission sequence number and the second transmission interval to the start point time, which is the time when the terminal 20a received the second transmission request notification. When the transmission standby ends, the data transmission unit 203 of the terminal 20a-1 or 20a-2 performs the transmission request response step of step S155 shown in FIG. 8 and transmits terminal data to the control device 10a by uplink communication.

Due to having the above configuration, the control device 10a according to the second embodiment can prevent frequent interference between terminals that have the same transmission sequence number in the case where there is both a group of terminals 20a for which the transmission sequence numbers have not been updated and a group of terminals 20a for which the transmission sequence numbers have been updated.

According to the present embodiment, it is possible to shorten the time required for collecting terminal data all at once from a large number of wireless terminals such as LPWA terminals.

[Hardware Configuration of Control Device]

The following describes an example of the hardware configuration of the control device 10 and the control device 10a. FIG. 14 is a device configuration diagram showing an example of the hardware configuration of the control device 10. The control device 10 includes a processor 51, a storage unit 52, a communication interface 53, and a user interface 54.

The processor 51 is a central processing unit that performs arithmetic computation and control. The processor 51 is a CPU, for example. By reading a program from the storage unit 52 and executing it, the processor 51 realizes functionality as the control unit 100, the simulation unit 101, the reception power acquisition unit 102, the logic slot allocation unit 103, the logic slot notification unit 105, the transmission request unit 106, the data reception unit 107, and the retransmission processing unit 108 in FIG. 3. The storage unit 52 is a recording medium such as any of various types of memories and storage devices. The storage unit 52 stores programs and the like for realize the processing of the simulation unit 101, the reception power acquisition unit 102, the logic slot allocation unit 103, the logic slot notification unit 105, the transmission request unit 106, the data reception unit 107, and the retransmission processing unit 108, and realizes the functionality of the storage unit 104. The storage unit 52 further has a work area for the processor 51 to execute various programs and the like. The communication interface 53 is communicably connected to other devices, and realizes the functionality of the reception power acquisition unit 102, the logic slot notification unit 105, the transmission request unit 106, the data reception unit 107, and the retransmission processing unit 108 in FIG. 3. The user interface 54 is an input device such as a keyboard or a pointing device such as a mouse, and a display device such as a display. Manual operations are input using the user interface 54. Note that the aforementioned programs can be recorded on a recording medium or provided through a network.

The hardware configuration of the control device 10a is similar to the hardware configuration of the control device 10 shown in FIG. 14. However, in the case of the control device 10a, the processor 51 realizes the functionality of the control unit 100, the simulation unit 101, the reception power acquisition unit 102, the logic slot allocation unit 103, the logic slot notification unit 105, the transmission request unit 106, the data reception unit 107, the retransmission processing unit 108, the second logic slot allocation unit 103a, the second storage unit 104a, the second logic slot notification unit 105a, the second transmission request unit 106a, and the switching unit 109. The storage unit 52 stores programs and the like for realize the processing of the simulation unit 101, the reception power acquisition unit 102, the logic slot allocation unit 103, the logic slot notification unit 105, the transmission request unit 106, the data reception unit 107, the retransmission processing unit 108, the second logic slot allocation unit 103a, the second storage unit 104a, the second logic slot notification unit 105a, the second transmission request unit 106a, and the switching unit 109, and realizes the functionality of the storage unit 104 and the second storage unit 104a. The communication interface 53 realizes the functionality of the reception power acquisition unit 102, the logic slot notification unit 105, the transmission request unit 106, the data reception unit 107, the retransmission processing unit 108, the second logic slot notification unit 105a, and the second transmission request unit 106a.

As described above, the program for realizing the functions of the control device 10 and the control device 10a can be recorded on a computer-readable recording medium, and the program recorded on the recording medium can read into a computer system and executed for realization. Note that the term “computer system” as used herein includes a processor, an OS, and hardware such as peripheral devices. Also, “computer-readable recording medium” refers to a portable medium such as a flexible disk, a magneto-optical disk, a ROM, or a CD-ROM, or a storage device such as a hard disk built in a computer system. Also, a “computer-readable recording medium” may dynamically hold the program for a short period of time, such as in the case of a communication line for transmitting a program via a network such as the Internet or a communication line such as a telephone line, or may hold the program for a certain period of time, such as in the case of a volatile memory inside a computer system that serves as a server or a client in the aforementioned case. Also, the above program may be for realizing a portion of the above-mentioned functions, may be for realizing the above-mentioned functions in combination with a program already recorded in the computer system, or may be realized by using hardware such as a PLD (Programmable Logic Device) or an FPGA. (Field Programmable Gate Array).

[Other Remarks]

According to the embodiment described above, a wireless communication system includes terminals and a control device. The control device controls the transmission sequence of packets transmitted by the terminals. The control device includes a logic slot allocation unit and a logic slot notification unit. The logic slot allocation unit generates a set of one or more terminals such that each terminal in the same set has at least one receiving base station, which is a base station that receives wireless communication from the terminal. The logic slot allocation unit allocates each set of terminals to a different logic slot. Each logic slot is a combination of one channel and one transmission sequence number. The logic slot notification unit notifies each terminal of the allocated logic slot.

Note that from among a plurality of base stations, the logic slot allocation unit sets, as the receiving base station of a terminal, a base station for which the ratio of the reception power of wireless communication from the terminal to the sum of reception powers of wireless communication from other terminals is greater than or equal to a threshold value. Also, in the logic slot allocation unit, a list of terminals that are candidates for allocation of the same logic slot may be a subset of all terminals for which a transmission sequence is to be determined. The logic slot allocation unit randomly selects the subset, or selects the subset from sets of terminals having different base stations at which the reception power is highest.

Also, the values of the reception power used by the logic slot allocation unit to determine the receiving base stations of the terminals may be the values of the reception power of uplink communication from the terminals that are actually measured at the base stations, or may be the values of the reception power for uplink communication from the terminals to the base stations calculated by radio wave propagation simulation.

Also, the control device further includes a transmission request unit that transmits a transmission request for data to the terminals by multicast. The terminal includes a logic slot notification acquisition unit, a transmission request acquisition unit, and a data transmission unit. The logic slot notification acquisition unit acquires a logic slot notification from the control device. The transmission request acquisition unit receives a transmission request from the control device. If the transmission request acquisition unit received the transmission request, the data transmission unit pauses transmission until arrival of a transmission timing calculated using the transmission sequence number indicated by the logic slot, and transmits a packet set with data using a channel number indicated by the logic slot at the transmission timing.

The control device may further include a second logic slot allocation unit, a second logic slot notification unit, and a second transmission request unit. Using terminals that have been allocated to logic slots and an added terminal, the second logic slot allocation unit generates a set of one or more terminals such that each terminal in the same set has at least one receiving base station, which is a base station that receives wireless communication from the terminal. The second logic slot allocation unit allocates each generated set of terminals to a second logic slot that has a different combination of a second channel and a second transmission sequence number. The second logic slot notification unit notifies each terminal of the second logic slot that was allocated. In the case where a response to the notification made by the second logic slot notification unit was received, the second transmission request unit transmits a second transmission request by multicast to the terminals using a second multicast address.

Also, each terminal may further include a second logic slot notification acquisition unit, a second transmission request acquisition unit, and a second data transmission unit. The second logic slot notification acquisition unit acquires a notification of the second logic slot from the control device. The second transmission request acquisition unit receives the second transmission request from the control device. In the case where the second transmission request acquisition unit received the second transmission request, the second data transmission unit pauses transmission until the arrival of a second transmission timing calculated using the second transmission sequence number indicated by the second logic slot, and transmits data using a second channel number indicated by the second logic slot at the second transmission timing indicated by the second logic slot.

Although embodiments of the present invention have been described in detail with reference to the drawings, the specific configuration is not limited to this embodiment, and includes designs and the like within a range that does not deviate from the gist of the present invention.

### REFERENCE SIGNS LIST

1 Wireless communication system
1a Wireless communication system
10 Control device
10a Control device
20 Terminal
20a Terminal
30r Base station
30g Base station
30g Base station
51 Processor
52 Storage unit
53 Communication interface
54 User interface
100 Control unit
101 Simulation unit
102 Reception power acquisition unit
103 Logic slot allocation unit
103a Second logic slot allocation unit
104 Storage unit
104a Second storage unit
105 Logic slot notification unit
105a Second logic slot notification unit
106 Transmission request unit
106a Second transmission request unit
107 Data reception unit
108 Transmission processing unit
109 Switching unit
200 Logic slot notification acquisition unit
200a Second logic slot notification acquisition unit
201 Storage unit
201a Second storage unit
202 Transmission request acquisition unit
202a Second transmission request acquisition unit
203 Data transmission unit
204 Immediate response request acquisition unit

1. A control device comprising:
a logic slot allocation unit configured to generate a set of one or more terminals such that each terminal included in the same set has at least one receiving base station, which is a base station that receives wireless communication from the terminal, and configured to allocate each generated set to a logic slot that has a different combination of a channel and a transmission sequence number; and
a logic slot notification unit configured to notify each terminal of the logic slot that was allocated to the terminal.

2. The control device according to claim 1,
wherein from among a plurality of base stations, the logic slot allocation unit sets, as the receiving base station of a terminal, a base station for which a ratio of a reception power of wireless communication from the terminal to a sum of reception powers of wireless communication from other terminals is greater than or equal to a threshold value.)

3. The control device according to claim 1,
wherein letting a list of terminals that are candidates for allocation of the same logic slot be a subset of all terminals for which a transmission sequence is to be determined, the logic slot allocation unit selects the subset from sets of terminals having different base stations at which the reception power of wireless communication from the terminal is highest.

4. A wireless communication system comprising a plurality of terminals and the control device according to claim 1,
the control device further comprising a transmission request unit configured to transmit a transmission request for data to the terminals by multicast, and
each of the terminals comprising:
a logic slot notification acquisition unit configured to acquire a logic slot notification from the control device;
a transmission request acquisition unit configured to receive the transmission request from the control device; and
a data transmission unit configured to, in a case where the transmission request acquisition unit received the transmission request, pause transmission until arrival of a transmission timing calculated using the transmission sequence number indicated by the logic slot, and configured to transmit data using a channel number indicated by the logic slot at the transmission timing.

5. The wireless communication system according to claim 4,
wherein the control device further comprises:
a second logic slot allocation unit configured to, using a terminal that has been allocated to a logic slot and an added terminal, generate a set of one or more terminals such that each terminal included in the same set has at least one receiving base station, which is a base station that receives wireless communication from the terminal, and configured to allocate each generated set to a second logic slot that has a different combination of a second channel and a second transmission sequence number;
a second logic slot notification unit configured to notify each terminal of the second logic slot that was allocated to the terminal; and
a second transmission request unit configured to, in a case where a response to the notification made by the second logic slot notification unit was received, transmit a second transmission request by multicast to the terminals using a second multicast address, and
each of the terminals further comprises:
a second logic slot notification acquisition unit configured to acquire a notification of the second logic slot from the control device;
a second transmission request acquisition unit configured to receive the second transmission request from the control device; and
a second data transmission unit configured to, in a case where the second transmission request acquisition unit received the second transmission request, pause transmission until arrival of a second transmission timing calculated using the second transmission sequence number indicated by the second logic slot, and configured to transmit data using a second channel number indicated by the second logic slot at the second transmission timing.

6. A communication control method comprising:
a logic slot allocation step of generating a set of one or more terminals such that each terminal included in the same set has at least one receiving base station, which is a base station that receives wireless communication from the terminal, and allocating each generated set to a logic slot that has a different combination of a channel and a transmission sequence number; and
a logic slot notification step of notifying each terminal of the logic slot that was allocated to the terminal.

7. A non-transitory computer-readable storage medium having a program for causing a computer to function as the control device according to claim 1.
